(19) United States
(12) Patent Application Publication
(10) Pub. No.: US 2021/0115212 A1
(43) Pub. Date: Apr. 22, 2021

(54) PROCESS FOR PRODUCING RIGID, FLAME-RETARDANT PU/PIR FOAM

(71) Applicant: Covestro Intellectual Property GmbH & Co. KG, Leverkusen (DE)

(72) Inventors: Rolf Albach, Köln (DE); Michael Schedler, Leverkusen (DE)

(21) Appl. No.: 17/042,245

(22) PCT Filed: Mar. 19, 2019
(86) PCT No.: PCT/EP2019/056751

§ 371 Date: Sep. 28, 2020

(30) Foreign Application Priority Data
Apr. 3, 2018 (EP) 18165398.1

(51) Int. Cl. C08J 9/00; C08G 18/42; C08G 18/76; C08K 5/00

(52) U.S. Cl. CPC C08J 9/0038; C08G 18/4238; C08G 18/7664; C08K 2003/026; C08J 2205/10; C08J 2375/04; C08K 5/0066

(57) ABSTRACT

The present invention relates to flame-retarded rigid polyurethane and/or polyurethane/polyisocyanurate foams (hereinafter individually or jointly also termed “rigid PUR/PIR foams”), and also to a process for producing rigid PUR/PIR foams that comprises reacting a reaction mixture comprising A1 an isocyanate-reactive component, A2 blowing agent A3 catalyst, A4 optionally additive, A5 flame retardant, and B an isocyanate component, and that is characterized in that the flame retardant A5 comprises at least two phosphorus-containing compounds, with one of the two compounds having the general formula R¹R²(O)P—[O—R⁵—R⁶—O—P(O)R³]ₙR⁴ (I) or R¹R²(O)P—[O—R⁵—X—R⁶—O—P(O)R³]ₙR⁴ (II), where X=an alkylene group, N—R⁷, O, CO, S, SO, SO₂ OR P—R⁷, n=an integer from 0 to 4, preferably 1 or 2, R¹, R², R³, R⁴=in each case an aryl-O—, aryl- or alkyl groups, R⁵, R⁶=in each case an arylene group, R⁷=an aryl-O—, aryl- or alkyl group, where the at least one compound having the general formula (I) or (II) is used in an oligomer mixture and on average the value (aa) of n is 0.80 to 4.00, preferably 0.90 to 2.00, more preferably 1.25 to 1.75.

The present invention relates to flame-retardant rigid polyurethane foams and rigid polyurethane/polyisocyanurate foams (hereinbelow also referred to individually or together as “PUR/PIR foams”) and also to processes for the production thereof and the use of the flame retardant mixture according to the invention in system for producing rigid PUR/PIR foams.

Like all organic polymers rigid PUR/PIR foams are flammable, the large surface area per unit mass in foams further reinforcing this behavior. Rigid PUR/PIR foams are often used as insulation materials, for example as insulation in the construction industry. Endowment with flame retardancy through added flame retardants is therefore necessary in many applications of rigid PUR/PIR foams. There are flame retardants which suffocate the flame in the gas phase and there are flame retardants which protect the surface of the polymeric material by favoring charring or forming a glassy coating. Preferably employed flame retardants include halogen-containing compounds and nitrogen and phosphorus compounds. Compounds containing halogens and low-valence phosphorus compounds are typical representatives of flame retardants that suffocate flames. Higher-valence phosphorus compounds are designed to bring about a catalytic cleavage of the polyurethanes in order to form a solid, polyphosphate-containing charred surface. This intumescence layer protects the material from further combustion (G. W. Becker, D. Braun: Polyurethane. In: G. Oertel (Ed.), Kunststoff Handbuch, Munich, Carl Hanser Verlag, 1983, 2, 104-1-5).

However, one disadvantage of the halogen-containing representatives of these classes in particular is that they are toxic and relatively volatile and can therefore migrate out of the foam (J. C. Quagliano, V. M. Wittemberg, I. C. G. Garcia: Recent Advances on the Utilization of Nanoclays and Organophosphorus Compounds in Polyurethane Foams for Increasing Flame Retardancy. In: J. Njuguna (Ed.), Structural Nanocomposites, Engineering Materials, Berlin Heidelberg, Springer Verlag, 2013, 1, 249-258) and that the use thereof results in the formation of corrosive hydrohalic acid in the combustion process.

The increasing prevalence of organic halogen compounds which in some cases have health-hazardous effects in the environment has shifted interest to halogen-free alternatives, for example to halogen-free phosphate esters and phosphite esters (S. V. Levchik, E. D. Weil: A Review of Recent Progress in Phosphorus-based Flame Retardants, J. Fire Sci., 2006, 24, 345-364) and to red phosphorus.

Most widespread are PUR and PIR foams that have been endowed with flame retardancy with organic phosphates such as tris(2-chlorisopropyl) phosphate (TCPP) and triethyl phosphate (TEP). Organic phosphonate esters such as dimethylpropanephosphonate (DMPP, DE 44 18 307 A1) or diethylethylphosphonate (DEEP, U.S. Pat. No. 5,268,393) have also been described as halogen-free flame retardants for isocyanate-based rigid PUR/PIR foams. Solid ammonium polyphosphate has likewise already been employed as a flame retardant (US 2014/066532 A1 and U.S. Pat. No. 5,470,891).

But these halogen-free alternatives also have disadvantages: They are in some cases sensitive to hydrolysis under the alkaline conditions typical for PUR/PIR foam systems, show inadequate effectiveness or have a flexibilizing effect. Red phosphorus has disadvantages for example in respect of rapid absorption of moisture and rapid oxidation which leads to a loss of flame retardancy and possibly formation of toxic phosphines and also has a propensity for powder explosions. Red phosphorus is often microencapsulated to overcome these problems. (L. Chen, Y.-Z. Wang: A review on flame retardant technology in China. Part 1: development of flame retardants, Polym. Adv. Technol., 2010, 21, 1-26).

JP 2007-277295 A describes the use of polycyclic phosphate esters having at least 3 benzene rings, for example tricresyl phosphate, as flame retardants in the production of rigid PUR foams.

While patent documents WO 2014/039488 A, US 2014/0066532 and WO 2014/055318 A do disclose the possible use of a compound of general formula (I) or (II) as a flame retardant an improvement in important mechanical properties such as dimensional stability under warm conditions is not described. U.S. Pat. No. 6,054,499, which describes a semirigid, open-celled expanding foam also gives no indication whatsoever of an effect of the flame retardant on mechanical properties, especially not on dimensional stability under warm conditions.

The present invention has for its object to allow the production of rigid PUR/PIR foams with halogen-free flame retardants, wherein the rigid PUR/PIR foams exhibit good flame retardancy and improved mechanical properties. The process according to the invention shall in particular afford rigid PUR/PIR foams which exhibit elevated compressive strength and improved dimensional stability compared to rigid PUR/PIR foams from the prior art.

This object could be achieved by a process for producing rigid PUR/PIR foams comprising reaction of a reaction mixture containing

A1 an isocyanate-reactive component

A2 blowing agent

A3 catalyst

A4 optionally additive

A5 flame retardant

B an isocyanate component,
characterized in that
the flame retardant A5 contains at least two phosphorus-containing compounds, wherein at least one of the two compounds has the general formula

R¹R²(O)P—[O—R⁵—R⁶—O—P(O)R³]ₙR⁴ (I)

or

R¹R²(O)P—[O—R⁵—X—R⁶—O—P(O)R³]ₙR⁴ (II)
wherein
X represents an alkylene group, N—R⁷, O, CO, S, SO, SO₂ or P—R⁷,
n represents an integer from 0 to 4, preferably 1 or 2,
R¹, R², R³, R⁴ in each case represents an aryl-O, aryl or alkyl group,
R⁵, R⁶ in each case represents an arylene group,
R⁷ represents an aryl-O, aryl or alkyl group,
wherein the at least one compound having the general formula (I) or (II) is employed in an oligomer mixture and n on average has a value n;⁻ of 0.80 to 4.00, preferably 0.90 to 2.00, particularly preferably 1.25 to 1.75.

It has surprisingly been found that not only do the rigid PUR/PIR foams according to the invention comprising a flame retardant mixture containing two phosphorus-containing compounds, wherein at least one compound has the general formula (I) or (II), exhibit a good flame retardancy but the compressive strength and dimensional stability of the rigid PUR/PIR foams is also improved compared to PUR/PIR foams from the prior art.

Employed as the isocyanate-reactive component A1 is at least one compound selected from the group consisting of polyether polyols, polyester polyols, polyether ester polyols, polycarbonate polyols and polyether-polycarbonate polyols. Polyester polyols and/or polyether polyols are preferred. The isocyanate-reactive component A1 can preferably have a hydroxyl number between 25 to 800 mg KOH/g, in particular 50 to 500 mg KOH/g and particularly preferably 100 to 300 mg KOH/g. The individual polyol component preferably has a number-average molecular weight of 50 g/mol to 2000 g/mol, particularly preferably 100 g/mol to 1000 g/mol, in particular 400 g/mol to 700 g/mol and very particularly preferably 450 g/mol to 600 g/mol. The functionality of the isocyanate-reactive component A1 may be for example between 1.0 to 8.0, preferably 1.0 to 6.0, in particular 1.0 to 4.0 and particularly preferably 1.5 to 3.0.

In the context of the present invention the number-average molar mass Mₙ (also known as molecular weight) is determined by gel permeation chromatography according to DIN 55672-1 (August 2007).

In the case of a single added polyol the OH number (also known as hydroxyl number) specifies the OH number of said polyol. Reported OH numbers for mixtures relate to the number-average OH number of the mixture calculated from the OH numbers of the individual components in their respective molar proportions. The OH number indicates the amount of potassium hydroxide in milligrams which is equivalent to the amount of acetic acid bound by one gram of substance during acetylation. The OH number is determined within the context of the present invention according to the standard DIN 53240-1 (June 2013).

Within the context of the present invention, “functionality” refers to the theoretical average functionality (number of isocyanate-reactive or polyol-reactive functions in the molecule) calculated from the known feedstocks and quantitative ratios thereof.

The equivalent weight specifies the ratio of the number-average molecular mass and the functionality of the isocyanate-reactive component. The reported equivalent weights for mixtures are calculated from equivalent weights of the individual components in their respective molar proportions and relate to the number-average equivalent weight of the mixture.

The polyester polyols of component A1 may be for example polycondensates of polyhydric alcohols, preferably diols, having 2 to 12 carbon atoms, preferably having 2 to 6 carbon atoms, and polycarboxylic acids, for example di-, tri- or even tetracarboxylic acids or hydroxycarboxylic acids or lactones, and it is preferable to employ aromatic dicarboxylic acids or mixtures of aromatic and aliphatic dicarboxylic acids. Also employable for preparing the polyesters instead of the free polycarboxylic acids are the corresponding polycarboxylic anhydrides or corresponding polycarboxylic esters of lower alcohols. It is preferable to use phthalic anhydride, terephthalic acid and/or isophthalic acid.

Useful carboxylic acids include in particular: succinic acid, glutaric acid, adipic acid, suberic acid, azelaic acid, sebacic acid, decanedicarboxylic acid, tetrahydrophthalic acid, hexahydrophthalic acid, cyclohexanedicarboxylic acid, tetrachlorophthalic acid, itaconic acid, malonic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, trimellitic acid, benzoic acid, trimellitic acid, maleic acid, fumaric acid, phthalic acid, isophthalic acid and terephthalic acid. Derivatives of these carboxylic acids can also be used, such as for example dimethyl terephthalate. The carboxylic acids may be used either individually or in admixture. Preferably employed as carboxylic acids are phthalic acid, terephthalic acid, glutaric acid, adipic acid, sebacic acid and/or succinic acid, particularly preferably adipic acid, phthalic acid and/or succinic acid.

Hydroxycarboxylic acids that may be co-employed as reaction participants in the preparation of a polyester polyol having terminal hydroxyl groups are for example hydroxycaproic acid, hydroxybutyric acid, hydroxydecanoic acid, hydroxystearic acid and the like. Suitable lactones include caprolactone, butyrolactone and homologs.

For preparing the polyester polyols, bio-based starting materials and/or derivatives thereof are in particular also suitable, for example castor oil, polyhydroxy fatty acids, ricinoleic acid, hydroxyl-modified oils, grapeseed oil, black cumin oil, pumpkin seed oil, borage seed oil, soybean oil, wheat germ oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified and epoxidized fatty acids and fatty acid esters, for example based on myristoleic acid, palmitoleic acid, oleic acid, vaccenic acid, petroselinic acid, gadoleic acid, erucic acid, nervonic acid, linoleic acid, alpha- and gamma-linolenic acid, stearidonic acid, arachidonic acid, timnodonic acid, clupanodonic acid and cervonic acid. Esters of ricinoleic acid with polyfunctional alcohols, for example glycerol, are especially preferred. Preference is also given to the use of mixtures of such bio-based acids with other carboxylic acids, for example phthalic acids.

Examples of suitable diols are ethylene glycol, butylene glycol, diethylene glycol, triethylene glycol, polyalkylene glycols such as polyethylene glycol, and also propane-1,2-diol, propane-1,3-diol, butane-1,3-diol, butane-1,4-diol, hexane-1,6-diol and isomers, neopentyl glycol or neopentyl glycol hydroxypivalate. Preference is given to using ethylene glycol, diethylene glycol, butane-1,4-diol, pentane-1,5-diol, hexane-1,6-diol or mixtures of at least two of the diols mentioned, in particular mixtures of butane-1,4-diol, pentane- 1,5 -diol and hexane-1,6-diol.

In addition, it is also possible to use polyols such as trimethylolpropane, glycerol, erythritol, pentaerythritol, trimethylolbenzene or trishydroxyethyl isocyanurate, with preference being given to glycerol and trimethylolpropane.

In addition, monohydric alkanols can also be used.

Polyether polyols used according to the invention are obtained by preparation methods known to those skilled in the art, such as for example by anionic polymerization of one or more alkylene oxides having 2 to 4 carbon atoms with alkali metal hydroxides, such as sodium or potassium hydroxide, alkali metal alkoxides, such as sodium methoxide, sodium or potassium ethoxide or potassium isopropoxide, or aminic alkoxylation catalysts, such as dimethylethanolamine (DMEOA), imidazole and/or imidazole derivatives, using at least one starter molecule containing 2 to 8, preferably 2 to 6, reactive hydrogen atoms in bonded form.

Suitable alkylene oxides are for example tetrahydrofuran, 1,3-propylene oxide, 1,2- and 2,3-butylene oxide, styrene oxide and preferably ethylene oxide and 1,2-propylene oxide. The alkylene oxides can be used individually, alternately in succession or as mixtures. Preferred alkylene oxides are propylene oxide and ethylene oxide and ethylene oxide is particularly preferred. The alkylene oxides may be reacted in combination with CO₂.

Examples of useful starter molecules include: water, organic dicarboxylic acids, such as succinic acid, adipic acid, phthalic acid and terephthalic acid, aliphatic and aromatic, optionally N-mono-, N,N- and N,N′-dialkyl-substituted diamines having 1 to 4 carbon atoms in the alkyl radical, such as optionally mono- and dialkyl-substituted ethylenediamine, diethylenetriamine, triethylenetetramine, 1,3-propylenediamine, 1,3- and 1,4-butylenediamine, 1,2-, 1,3-, 1,4-, 1,5- and 1,6-hexamethylenediamine, phenylenediamines, 2,3-, 2,4- and 2,6-tolylenediamine and 2,2′-, 2,4′- and 4,4′-diaminodiphenylmethane.

Preference is given to using dihydric or polyhydric alcohols such as ethanediol, propane-1,2- and —1,3-diol, diethylene glycol, dipropylene glycol, butane-1,4-diol, hexane-1,6-diol, triethanolamine, bisphenols, glycerol, trimethylolpropane, pentaerythritol, sorbitol and sucrose.

Polycarbonate polyols that may be used are polycarbonates having hydroxyl groups, for example polycarbonate diols. These are formed in the reaction of carbonic acid derivatives, such as diphenyl carbonate, dimethyl carbonate or phosgene, with polyols, preferably diols.

Examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenols, and lactone-modified diols of the abovementioned type.

Instead of or in addition to pure polycarbonate diols, it is also possible to use polyether polycarbonate diols obtainable for example by copolymerization of alkylene oxides, such as for example propylene oxide, with CO₂.

Usable polyether ester polyols are compounds containing ether groups, ester groups and OH groups. Organic dicarboxylic acids having up to 12 carbon atoms are suitable for preparing the polyether ester polyols, preferably aliphatic dicarboxylic acids having 4 to 6 carbon atoms or aromatic dicarboxylic acids used individually or in a mixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. In addition to organic dicarboxylic acids, derivatives of these acids can also be used, for example their anhydrides and also their esters and half-esters with low molecular weight monofunctional alcohols having 1 to 4 carbon atoms. The use of proportions of the abovementioned bio-based starting materials, in particular of fatty acids/fatty acid derivatives (oleic acid, soybean oil etc.), is likewise possible and can have advantages, for example in respect of storage stability of the polyol formulation, dimensional stability, fire behavior and compressive strength of the foams.

Polyether polyols obtained by alkoxylation of starter molecules such as polyhydric alcohols are a further component used for preparing polyether ester polyols. The starter molecules are at least difunctional, but may optionally also contain proportions of higher-functional, in particular trifunctional, starter molecules.

Starter molecules include for example diols such as 1,2-ethanediol, 1,3-propanediol, 1,2-propanediol, 1,4-butanediol, 1,5-pentenediol, 1,5-pentanediol, neopentyl glycol, 1,6-hexanediol, 1,7-heptanediol, 1,8-octanediol, 1,10-decanediol, 2-methyl- 1,3-propanediol, 2,2 -dimethyl-1,3 -propanediol, 3-methyl-1,5-pentanediol, 2 -butyl-2-ethyl-1,3-propanediol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomeric mixtures of alkylene glycols, such as diethylene glycol. Starter molecules having functionalities other than OH can also be used alone or in a mixture.

In addition to the diols, starter molecules also used for preparing the polyethers may also be compounds having more than 2 Zerewitinoff-active hydrogens, in particular having number-average functionalities of 3 to 8, in particular of 3 to 6, for example 1,1,1-trimethylolpropane, triethanolamine, glycerol, sorbitan and pentaerythritol and also triol- or tetraol-started polyethylene oxide polyols.

Polyether ester polyols may also be prepared by the alkoxylation, in particular by ethoxylation and/or propoxylation, of reaction products obtained by the reaction of organic dicarboxylic acids and their derivatives and components with Zerewitinoff-active hydrogens, in particular diols and polyols. Derivatives of these acids that may be employed include for example their anhydrides, for example phthalic anhydride.

Processes for preparing the polyols have been described for example by Ionescu in “Chemistry and Technology of Polyols for Polyurethanes”, Rapra Technology Limited, Shawbury 2005, p. 55 .f. (chapt. 4: Oligo-Polyols for Elastic Polyurethanes), p. 263 ff. (chapt. 8: Polyester Polyols for Elastic Polyurethanes) and in particular on p. 321 ff. (chapt. 13: Polyether Polyols for Rigid Polyurethane Foams) and p. 419 ff. (chapt. 16: Polyester Polyols for Rigid Polyurethane Foams). It is also possible to obtain polyester and polyether polyols by glycolysis of suitable polymer recyclates. Suitable polyether polycarbonate polyols and the preparation thereof are described, for example, in EP 2 910 585 A1, [0024]-[0041]. Examples of polycarbonate polyols and the preparation thereof can be found, inter alia, in EP 1 359 177 A1. The preparation of suitable polyether ester polyols has been described, inter alia, in WO 2010/043624 A and in EP 1 923 417 A.

The isocyanate-reactive component A1 may further contain low molecular weight isocyanate-reactive compounds, in particular di- or trifunctional amines and alcohols, particularly preferably diols and/or triols having molar masses Mₙ of less than 400 g/mol, preferably of 60 to 300 g/mol, for example triethanolamine, diethylene glycol, ethylene glycol and glycerol, may be employed. Provided such low molecular weight isocyanate-reactive compounds are used for producing the rigid polyurethane foams, for example as chain extenders and/or crosslinking agents, these are advantageously employed in an amount of up to 10% by weight based on the total weight of component A1.

In addition to the above-described polyols and isocyanate-reactive compounds the component A1 may contain further isocyanate-reactive compounds, for example graft polyols, polyamines, polyamino alcohols and polythiols. Of course, the isocyanate-reactive components described also comprise those compounds having mixed functionalities.

The component A1 may consist of one or more of the abovementioned isocyanate-reactive components.

Employable blowing agents A2 include physical blowing agents such as for example low-boiling organic compounds, for example, hydrocarbons, halogenated hydrocarbons, ethers, ketones, carboxylic esters or carbonic esters. Organic compounds inert towards the isocyanate component B and having boiling points below 100° C., preferably below 50° C., at atmospheric pressure are suitable in particular. These boiling points have the advantage that the organic compounds evaporate under the influence of the exothermic polyaddition reaction. Examples of such preferably used organic compounds are alkanes, such as heptane, hexane, n-pentane and isopentane, preferably technical grade mixtures of n-pentane and isopentane, n-butane and isobutane and propane, cycloalkanes, such as for example cyclopentane and/or cyclohexane, ethers, such as for example furan, dimethyl ether and diethyl ether, ketones, such as for example acetone and methyl ethyl ketone, alkyl carboxylates, such as for example methyl formate, dimethyl oxalate and ethyl acetate and halogenated hydrocarbons, such as for example methylene chloride, dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane and heptafluoropropane. Also preferred is the use of (hydro)fluorinated olefins, for example HFO 1233zd(E) (trans-1-chloro-3,3,3-trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4-(trifluoromethyl)pent-2-ene). It is also possible to use mixtures of two or more of the organic compounds mentioned. The organic compounds may also be used here in the form of an emulsion of small droplets. It is preferable to employ hydrocarbons having a lower explosive limit of <1.9%. The lower explosive limit is the lowest volume concentration of the hydrocarbon in air at which the hydrocarbon-air mixture is explosive in the presence of an ignition source. Examples of hydrocarbons having a lower explosive limit of <1.9% are n-pentane, isopentane, cyclopentane, butane, hexane, 2-methylpentane and pentene. It is particularly preferable when the hydrocarbon having a lower explosive limit of <1.9% is an alkane.

Employable blowing agents A2 further include chemical blowing agents, for example water, carboxylic acid and mixtures thereof. These react with isocyanate groups to form the blowing gas, forming carbon dioxide for example in the case of water and forming carbon dioxide and carbon monoxide for example in the case of formic acid. The carboxylic acid used is preferably at least one compound selected from the group consisting of formic acid, acetic acid, oxalic acid and ricinoleic acid. The chemical blowing agent used is particularly preferably water.

Halogenated hydrocarbons are preferably not used as blowing agent.

At least one compound selected from the group consisting of physical and chemical blowing agents is employed as blowing agent A2. Preference is given to using only physical blowing agent.

Employed as catalysts A3 for producing the rigid PUR/PIR foams are compounds which accelerate the reaction of the compounds containing reactive hydrogen atoms, in particular hydroxyl groups, with the isocyanate component B, such as for example tertiary amines or metal salts. The catalyst components may be metered into the reaction mixture or else completely or partially initially charged in the isocyanate-reactive component A1.

Compounds employed are for example tertiary amines, such as triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cyclohexylmorpholine, N,N,N′,N′-tetramethylethylenediamine, N,N,N,N-tetramethylbutanediamine, N,N,N,N-tetramethylhexane-1,6-diamine, pentamethyldiethylenetriamine, bis[2-(dimethylamino)ethyl] ether, dimethylpiperazine, N-dimethylaminoethylpiperidine, 1,2 -dimethylimidazole, 1-azabicyclo[3,3,0]octane, 1,4-diazabicyclo[2,2,2]octane (Dabco) and alkanolamine compounds such as triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazine, for example N,N′,N″-tris(dimethylaminopropyl)hexahydrotriazine and triethylenediamine.

Metal salts, for example alkali metal or transition metal salts, may also be used. Transition metal salts used are for example zinc salts, bismuth salts, iron salts, lead salts or preferably tin salts. Examples of transition metal salts used are iron(II) chloride, zinc chloride, lead octoate, tin dioctoate, tin diethylhexoate and dibutyltin dilaurate. The transition metal salt is particularly preferably selected from at least one compound from the group consisting of tin dioctoate, tin diethylhexoate and dibutyltin dilaurate. Examples of alkali metal salts are alkali metal alkoxides such as for example sodium methoxide and potassium isopropoxide, alkali metal carboxylates such as for example potassium acetate, and also alkali metal salts of long-chain fatty acids having 10 to 20 carbon atoms and optionally pendant OH groups. It is preferable to employ one or more alkali metal carboxylates as the alkali metal salt.

Useful catalysts A3 furthermore include: Amidines, for example 2,3-dimethyl-3,4,5,6-tetrahydropyrimidine, tetraalkylammonium hydroxides, for example tetramethylammonium hydroxide, alkali metal hydroxides, for example sodium hydroxide, and tetraalkylammonium carboxylates or phosphonium carboxylates. Mannich bases and salts of phenols are also suitable catalysts. It is also possible to perform the reactions without catalysis. In this case the catalytic activity of amine-started polyols is utilized.

If a relatively large polyisocyanate excess is used when foaming, useful catalysts for the trimerization reaction of the excess NCO groups with one another furthermore include: isocyanurate-forming catalysts, for example ammonium ion salts or alkali metal salts, especially ammonium carboxylates or alkali metal carboxylates, alone or in combination with tertiary amines. Isocyanurate formation results in particularly flame-retardant rigid PIR foams.

The abovementioned catalysts may be used alone or in combination with one another.

One or more additives may optionally be used as component A4. Examples of component A4 are surface-active substances, foam stabilizers, cell regulators, fillers, dyes, pigments, hydrolysis stabilizers, fungistatic and bacteriostatic substances.

Contemplated surface-active substances include for example compounds that serve to promote the homogenization of the starting substances and are optionally also suitable for regulating the cell structure of the plastics. Examples include emulsifiers, such as the sodium salts of castor oil sulfates or of fatty acids and salts of fatty acids with amines, for example diethylamine oleate, diethanolamine stearate, diethanolamine ricinoleate, salts of sulfonic acids, for example alkali metal or ammonium salts of dodecylbenzenedisulfonic acid or dinaphthylmethanedisulfonic acid and ricinoleic acid; foam stabilizers, such as siloxane oxyalkylene mixed polymers and other organopolysiloxanes, ethoxylated alkylphenols, ethoxylated fatty alcohols, paraffin oils, castor oil esters or ricinoleic esters, Turkey red oil and peanut oil, and cell regulators, such as paraffins, fatty alcohols and dimethylpolysiloxanes. The above-described oligomeric acrylates having polyoxyalkylene and fluoroalkane radicals as side groups are also suitable for improving emulsifying action, cell structure and/or stabilization of the foam.

Suitable fillers, in particular reinforcing fillers, are the customary organic and inorganic fillers, reinforcers, weighting agents, agents for improving abrasion characteristics in paints, coating agents etc. which are known per se. These especially include for example: inorganic fillers such as siliceous minerals, for example phyllosilicates such as antigorite, serpentine, hornblendes, amphiboles, chrysotile, montmorillonite and talc, metal oxides such as kaolin, aluminum oxides, titanium oxides and iron oxides, metal salts, such as chalk, barite and inorganic pigments such as cadmium sulfide and zinc sulfide and also glass inter alia, and natural and synthetic fibrous minerals such as wollastonite, metal fibers and in particular glass fibers of various lengths which may optionally have been coated with a size. Examples of contemplated organic fillers include: carbon, melamine, colophony, cyclopentadienyl resins and graft polymers and also cellulose fibers, polyamide fibers, polyacrylonitrile fibers, polyurethane fibers and polyester fibers based on aromatic and/or aliphatic dicarboxylic esters and carbon fibers.

According to the invention the flame retardant A5 contains at least two phosphorus-containing compounds, wherein at least one of the two compounds has the general formula

R¹R²(O)P—[O—R⁵—R⁶—O—P(O)R³]ₙR⁴ (I)

or

R¹R²(O)P—[O—R⁵—X—R⁶—O—P(O)R³]ₙR⁴ (II)
wherein
X represents an alkylene group, N—R⁷, O, CO, S, SO, SO₂ or P—R⁷,
n represents an integer from 0 to 4, preferably 1 or 2,
R¹, R², R³, R⁴ in each case represents an aryl-O, aryl or alkyl group,
R⁵, R⁶ in each case represents an arylene group,
R⁷ represents an aryl-O, aryl or alkyl group,
wherein the at least one compound having the general formula (I) or (II) is employed in an oligomer mixture and n on average has a value n;⁻ of 0.80 to 4.00, preferably 0.90 to 2.00, particularly preferably 1.25 to 1.75.
   enthaltend ist.

The groups R¹, R², R³ and R⁴ of the compound having general formula (I) or (II) each represent an aryl-O, aryl or alkyl group. It is preferable when R¹, R², R³ and R⁴ each represent an aryl-O group. An alkyl group may be for example a methyl, ethyl, butyl, propyl or methylpropyl group, an aryl group may be for example a phenyl, naphthyl or phenanthryl group, an aryl-O group may be for example a phenoxy or naphthoxy group. R¹, R², R³ and R⁴ preferably each represent a phenoxy group. The groups R⁵ and R⁶ each represent an arylene group such as for example phenylene, naphthylene or biphenylene group, preferably phenylene group. Group X represents an alkylene group, for example methylene, ethylene, propylene, butylene, methylpropylene, methylbutylene or isopropylidene group, preferably ethylene, methylpropylene or isopropylene group. The group R⁷ of the compound having general formula (I) or (II) represents an aryl-O, aryl or alkyl group. R⁷ preferably represents an alkyl group. In the compound having the general formula (I) or (II) n represents an integer from 0 to 4, wherein compounds having the general formula (I) or (II) are employed as an oligomer mixture. Oligomer mixture is here to be understood as meaning in each case a mixture of compounds having the general formula (I) oder (II), wherein the compounds in the mixture differ only in the value of n. The molar average of n present in the respective oligomer mixture of compounds having the general formula (I) or (II) is calculated as follows:
n;⁻=Σxᵢnᵢ where xᵢ=mole fraction and nᵢ=value n for the oligomer i,
and is 0.80 to 4.00, preferably 0.90 to 2.00, particularly preferably 1.25 to 1.75.

Most preferably employed as the compound having the general formula (I) or (II) is bisphenol A bis(diphenylphosphate).

The proportion of a compound having the general formula (I) or (II) in the flame retardant A5 may be for example 45.0% by weight to 95.0% by weight, preferably 80.0% by weight to 95.0% by weight and particularly preferably 88.0% by weight to 94.0% by weight in each case based on the total mass of the flame retardant A5. The proportion of a compound having the formula (I) or (II) may be for example 5.0% by weight to 40.0% by weight, preferably 10.0% by weight to 30.0% by weight, particularly preferably 18.0% to 28.0% by weight, in each case based on the total mass of the components A1 to A5.

Further phosphorus-containing compounds employable in addition to at least one compound having the formula (I) or (II) are for example phosphates or phosphonates, for example diethylethyl phosphonate (DEEP), triethyl phosphate (TEP), triphenyl phosphate (TPP), tricresyl phosphate, diphenylcresyl phosphate (DPC), dimethylmethyl phosphonate (DMMP), diethyl diethanolaminomethylphosphonate, diethylhydroxymethyl phosphonate, 9,10-dihydro-9-oxa-10-phosphorylphenanthrene-10-oxide (DOPO) and dimethylpropylphosphonate (DMPP) and chlorinated phosphates such as tris(2-chlorethyl)phosphate, tris(2-chlorpropyl)phosphate (TCPP), tris(1,3-dichlorpropyl)phosphate, tris(2,3 -dibrompropyl)phosphate, tetrakis(2-chlorethyl)ethylenediphosphate. It is preferable to employ diphenylcresyl phosphate, triethyl phosphate or red phosphorus.

Further suitable flame retardants A5 are for example brominated esters, brominated ethers (Ixol) or brominated alcohols such as dibromoneopentyl alcohol, tribromoneopentyl alcohol, tetrabromophthalate diol and commercially available halogen-containing flame retardant polyols.

It is most preferable not to employ halogen-containing flame retardant.

Contemplated suitable isocyanate components B are for example polyisocyanates, i.e. isocyanates having an NCO functionality of at least 2. Examples of such suitable polyisocyanates include 1,4-butylene diisocyanate, 1,5-pentanediisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1- to C6-alkyl groups. The isocyanate component B is preferably selected from at least one compound from the group consisting of MDI, polymeric MDI and TDI.

In addition to the abovementioned polyisocyanates, it is also possible to co-use proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

Also employable as the isocyanate component B instead of or in addition to the abovementioned polyisocyanates are suitable NCO prepolymers. The prepolymers are producible by reaction of one or more polyisocyanates with one or more polyols corresponding to the polyols described under the isocyanate-reactive components A1.

The isocyanate index (also known as the index) is to be understood as meaning the quotient of the actually employed amount of substance [mol] of isocyanate groups and the actually employed amount of substance [mol] of isocyanate-reactive groups, multiplied by 100:
index=(moles of isocyanate groups/moles of isocyanate-reactive groups) * 100

In the reaction mixture the ratio of the number of NCO groups in the isocyanate to the number of isocyanate-reactive groups may result in an isocyanate index of 90 to 600, preferably between 250 and 450. This isocyanate index is preferably in a range from 300 to 400 in which a high proportion of polyisocyanurates (PIR) is present (the rigid foam is referred to as a rigid PIR foam foam or rigid PUR/PIR foam) and results in a higher flame retardancy of the rigid PUR/PIR foam itself. Another preferred range for the isocyanate index is the range from >90 to <150 (the rigid foam is referred to as a polyurethane foam (rigid PUR foam)) in which the rigid PUR/PIR foam tends to have a reduced brittleness for example.

The NCO value (also known as NCO content, isocyanate content) is determined according to EN ISO 11909 (May 2007). Unless otherwise stated values measured at 25° C. are concerned.

The invention likewise relates to a rigid PUR/PIR foam produced by the process according to the invention.

The rigid PUR/PIR foams according to the invention are produced by one-step processes known to those skilled in the art and in which the reaction components are continuously or discontinuously reacted with one another and then subsequently introduced either manually or with the aid of mechanical equipment in the high-pressure or low-pressure process after discharge onto a conveyor belt or into suitable molds for curing. Examples are described in U.S. Pat. No. 2,764,565, in G. Oertel (ed.) “Kunststoff-Handbuch”, Volume VII, Carl Hanser Verlag, 3rd edition, Munich 1993, pages 267 ff., and in K. Uhlig (ed.) “Polyurethan Taschenbuch”, Carl Hanser Verlag, 2nd edition, Vienna 2001, pages 83-102.

The rigid PUR/PIR foams of the invention preferably have a phosphorus proportion of 5 to 20 g of phosphorus per kilogram of foam.

The rigid PUR/PIR foams of the invention are preferably used for the production of composite elements. The foaming typically takes place here continuously or discontinuously against at least one outer layer.

The invention accordingly further provides for the use of a rigid PUR/PIR foam according to the invention as an insulation foam and/or as an adhesion promoter in composite elements, wherein the composite elements comprise a layer comprising a rigid PUR/PIR foam according to the invention and an outer layer. The outer layer is at least partially contacted by a layer comprising the rigid PUR/PIR foam according to the invention. Composite elements of the type of interest here are also known as sandwich elements or insulation panels and are generally used as building elements for soundproofing, insulation, for commercial buildings or for facade construction. The outer layers may be formed for example by rolls of metal or plastics or particleboards of up to 7 mm in thickness depending on the application of the composite elements. The one or two outer layers may in each case be a flexible outer layer, for example made of an aluminum foil, paper, multilayer outer layers made of paper and aluminum or of mineral nonwovens and/or a rigid outer layer, for example made of sheet steel or particleboard.

In a first embodiment the invention relates to a process for producing rigid PUR/PIR foams comprising reaction of a reaction mixture containing

A1 an isocyanate-reactive component

A2 blowing agent

A3 catalyst

A4 optionally additive

A5 flame retardant

B an isocyanate component,
characterized in that
the flame retardant A5 contains at least two phosphorus-containing compounds, wherein at least one of the two compounds has the general formula

R¹R²(O)P—[O—R⁵—R⁶—O—P(O)R³]ₙR⁴ (I)

or

R¹R²(O)P—[O—R⁵—X—R⁶—O—P(O)R³]ₙR⁴ (II)
wherein
X represents an alkylene group, N—R⁷, O, CO, S, SO, SO₂ or P—R⁷,
n represents an integer from 0 to 4, preferably 1 or 2,
R¹, R², R³, R⁴ in each case represents an aryl-O, aryl or alkyl group,
R⁵, R⁶ in each case represents an arylene group,
R⁷ represents an aryl-O, aryl or alkyl group,
wherein the at least one compound having the general formula (I) or (II) is employed in an oligomer mixture and n on average has a value n;⁻ of 0.80 to 4.00, preferably 0.90 to 2.00, particularly preferably 1.25 to 1.75.

In a second embodiment the invention relates to a process according to the first embodiment, characterized in that the isocyanate-reactive component A1 contains a polyester polyol.

In a third embodiment the invention relates to a process according to the embodiment 2, characterized in that the isocyanate-reactive component A1 contains a polyester polyol and a polyether polyol each having a molecular weight of 50 g/mol to 2000 g/mol, preferably 100 g/mol to 1000 g/mol, particularly preferably 400 g/mol to 700 g/mol and very particularly preferably 450 g/mol to 600 g/mol.

In a fourth embodiment the invention relates to a process according to either of embodiments 2 and 3, characterized in that the isocyanate-reactive component A1 contains a polyester polyol and a polyether polyol each having a functionality of 1.0 to 6.0, preferably 1.0 to 4.0, particularly preferably 1.5 to 3.0.

In a fifth embodiment the invention relates to a process according to any of embodiments 1 to 4, characterized in that the blowing agent A2 is selected from one or more compounds from the group consisting of halogen-free chemical blowing agents, halogen-free physical blowing agents and (hydro)fluorinated olefins.

In a sixth embodiment the invention relates to a process according to any of embodiments 1 to 5, characterized in that the flame retardant A5 contains 45.0% by weight to 95.0% by weight, preferably 80.0% by weight to 95.0% by weight, particularly preferably 88.0% by weight to 94.0% by weight, in each case based on the total mass of the flame retardant A5, of a compound of general formula (I) or (II).

In a seventh embodiment the invention relates to a process according to any of embodiments 1 to 6, characterized in that the proportion of a compound having the general formula (I) oder (II) is 5.0% by weight to 40.0% by weight, preferably 10.0% by weight to 30.0% by weight, particularly preferably 18.0% by weight to 28.0% by weight, in each case based on the total mass of the components A1 to A5.

In an eighth embodiment the invention relates to a process according to any of embodiments 1 to 7, characterized in that the flame retardant A5 contains no halogen-containing flame retardant.

In a ninth embodiment the invention relates to a process according to any of embodiments 1 bis 8, characterized in that the flame retardant A5 contains a compound having the general formula (I) or (II), wherein R¹, R², R³ and R⁴ each represent an aryl-O group.

In a tenth embodiment the invention relates to a process according to embodiment 8, characterized in that the flame retardant A5 contains a compound having the general formula (I) or (II), wherein R¹, R², R³ and R⁴ each represent a phenoxy group.

In an eleventh embodiment the invention relates to a process according to embodiment 10, characterized in that bisphenol A bis(diphenylphosphate) is containing.

In a twelfth embodiment the invention relates to a process according to any of embodiments 1 to 11, characterized in that in addition to a compound having the general formula (I) or (II) the flame retardant A5 contains a flame retardant selected from the group consisting of diphenylcresyl phosphate, triethyl phosphate and red phosphorus.

In a thirteenth embodiment the invention relates to a process according to any of embodiments 1 to 12, characterized in that the isocyanate component B is selected from at least one compound from the group consisting of MDI, polymeric MDI and TDI.

In a fourteenth embodiment the invention relates to a rigid PUR/PIR foam obtainable by the process according to any of embodiments 1 to 13.

In a fifteenth embodiment the invention relates to the use of rigid PUR/PIR foams according to embodiment 14 for producing an insulation material.

In a sixteenth embodiment the invention relates to a process according to the first embodiment, characterized in that the reaction mixture contains

A1 a polyester polyol having a number-average molecular weight of 50 g/mol to 2500 g/mol and a hydroxyl number of 50 mg KOH/g to 400 mg KOH/g,

A2 blowing agent containing a compound selected from the group consisting of halogen-free chemical blowing agents, halogen-free physical blowing agents and (hydro)fluorinated olefins,

A3 catalyst containing alkali metal carboxylate,

A4 additive containing a foam stabilizer,

A5 flame retardant containing a compound having the general formula (I) or (II),
wherein
X represents an alkylene group, N—R⁷, O, S, SO, SO₂ or P—R⁷,
n represents an integer from 0 to 2.00,
R¹, R², R³ and R⁴ each represents a phenoxy group,
R⁵, R⁶ in each case represents an arylene group,
R⁷ represents an alkyl group,
wherein the at least one compound having the general formula (I) or (II) is employed in an oligomer mixture and n on average has a value n;⁻ of 0.80 to 2.00,
and at least one compound selected from the group consisting of phosphates and phosphonates,

B monomeric and polymeric MDI.

In a seventeenth embodiment the invention relates to a process according to the first embodiment, characterized in that the reaction mixture contains

A1 50% by weight to <90% by weight of one or more polyester polyols and 5% by weight to 20% by weight of one or more polyether polyols, in each case based on the total weight of the component A1,

A2 physical blowing agents,

A3 catalyst,

A4 optionally additive,

A5 flame retardant containing a compound having the general formula (I) or (II) and a compound selected from the group consisting of diphenylcresyl phosphate, triethyl phosphate and red phosphorus,

B polymeric isocyanate.

In an eighteenth embodiment the invention relates to a process according to any of embodiments 1 to 13, characterized in that the blowing agent A2 consists of at least one hydrocarbon having a lower explosive limit <1.9% and optionally chemical blowing agents.

The preferred embodiments may be performed individually or else in conjunction with one another.

### EXAMPLES

### 1. Reactants

A1-1 polyester polyol composed of glutaric acid, succinic acid, adipic acid, ethylene glycol and diethylene glycol having a functionality of 2 and a molecular weight of 520 g/mol

A1-2 polyester polyol composed of phthalic acid, adipic acid, ethylene glycol and diethylene glycol having a functionality of 2 and a molecular weight of 460 g/mol

A1-3 polyether polyol on 1,2-propylene glycol started with 70% by weight of propylene oxide and 29% by weight of ethylene oxide, functionality of 2 and a molecular weight of 4000 g/mol

A1-4 polyether polyol composed of propylene oxide with a starting mixture of sorbitol and glycerol, functionality of 4.5 and a molecular weight of 600 g/mol

A1-5 triethanolamine

A2-1 n-pentane

A2-2 water

A3-1 25% by weight of potassium acetate in diethylene glycol (catalyst)

A3-2 dimethylcyclohexylamine (catalyst)

A4-1 polyether-modified polydimethylsiloxane (foam stabilizer)

A5-1 bisphenol A bis(diphenyl phosphate) (Fyroflex® BDP, ICL Industrial Products) having an average value of n;⁻=1.50

A5-2 red phosphorus (Acros)

A5-3 diphenylcresyl phosphate DPC

A5-4 resorcinyl diphenyl phosphate RDP (Fyrolflex RDP, ICL)

A5-5 triethyl phosphate (disflammol TEP, Lanxess)

B-1 polymeric MDI comprising 31.5% by weight of NCO groups and a viscosity of 700 mPa·s at 25° C.

### Production and Testing of Rigid PUR/PIR Foams

The flame spread of the rigid PUR/PIR foams was measured by edge flaming with the small burner test according to DIN 4102-1 (May 1998) on a sample having dimensions of 18 cm×9 cm×2 cm. The destroyed sample length is a measure for the fire safety properties of the employed flame retardant, wherein a shorter destroyed sample length represents better flame retardancy.

The compressive strength of the rigid PUR/PIR foams was determined according to DIN EN 826 (May 2013) on test specimens having dimensions of 50 mm×50 mm×50 mm. The compressive strength of the test specimens was measured in the foaming direction and perpendicular to the foaming direction.

Measurement of apparent density was performed according to DIN EN ISO 845 (October 2009).

To measure the dimensional stability of the rigid PUR/PIR foams test specimens having dimensions of 5 cm×5 cm×5 cm were measured centrally in the three directions. The test specimens were stored for 22 hours at 100° C. in a circulating air drying cabinet and after cooling of the test specimens to 20° C. measured once again. The dimensional stability @100° C. corresponds to the geometric quadratic average of the changes in side lengths in three directions at 100° C. over 22 hours.

The open-cell content of the rigid PUR/PIR foams was measured with an Accupyk-1330 instrument on test specimens having dimensions of 5 cm×3 cm×3 cm according to DIN EN ISO 4590 (August 2003).

To determine the phosphorus proportion of the obtained rigid PUR/PIR foams the weight fraction of phosphorus in phosphorus-containing compounds in the reaction mixture is calculated and related to the total mass of the reaction mixture.

Based on the polyol components rigid PUR/PIR foams were produced in the laboratory by mixing 0.3 dm³ of a reaction mixture in a paper cup. To this end the flame retardant, the foam stabilizer, catalysts and n-pentane as the blowing agent were added to the respective polyol component and the mixture was briefly stirred. The obtained mixture was mixed with the isocyanate and the reaction mixture was poured into a paper mold (3×3×1 dm³) and reacted therein. The precise formulations of the individual experiments are reported in table 1 and table 2 (composition of the reaction mixtures), likewise the results of the physical measurements on the obtained samples (table 1/2, physical properties).

TABLE 1
Composition of the reaction mixtures (examples 1-4)

| Examples | | 1* | 2 | 3* | 4 |
|---|---|---|---|---|---|
| A1-1 | parts by wt. | 23.8 | 23.8 | 22.8 | 22.8 |
| A1-2 | parts by wt. | 21.5 | 21.5 | 20.6 | 20.6 |
| A1-3 | parts by wt. | 6.3 | 6.3 | 6 | 6 |
| A1-4 | parts by wt. | 32.6 | 32.6 | 31.1 | 31.1 |
| A1-5 | parts by wt. | 5.0 | 5.0 | 4.8 | 4.8 |
| A2-1 | parts by wt. | 3.6 | 3.6 | 4.2 | 4.2 |
| A2-2 | parts by wt. | 3.1 | 3.1 | 3 | 3 |
| A3-1 | parts by wt. | 1.0 | 1.0 | 1 | 1 |
| A3-2 | parts by wt. | 1.0 | 1.0 | 1 | 1 |
| A4-1 | parts by wt. | 3.1 | 3.1 | 3 | 3 |
| Flame retardant | | | | | |
| A5-1 | parts by wt. | | 18.0 | | 27.8 |
| A5-2 | parts by wt. | 2.5 | 2.5 | 2.5 | 2.5 |
| A5-3 | parts by wt. | 19.3 | | 27.8 | |
| Isocyanate | | | | | |
| B-1 | parts by wt. | 181.9 | 181.9 | 174 | 174 |
| Index | | 148.5 | 148.5 | 148.5 | 148.5 |
| Physical properties | | | | | |
| Cream time | s | 17 | 15 | 16 | 15 |
| Fiber time to | s | 37 | 35 | 36 | 35 |
| Tack-free time | s | 98 | 78 | 78 | 65 |
| Apparent core density | kg/m³ | 37.3 | 38.0 | 38.3 | 38.9 |
| Dimensional | % | 1.1 | 0.6 | 5.1 | 0.6 |
| stability@100° C. | | | | | |
| Open-cell content | % | 6 | 6 | 6.5 | 6.1 |
| Compressive strength | kPa | 333 | 354 | 328 | 350 |
| in foaming direction | | | | | |
| Compressive strength | kPa | 155 | 184 | 145 | 181 |
| perpendicular to foaming | | | | | |
| Phosphorus content in | g/kg¹⁾ | 19.5 | 18.5 | 18.1 | 16.5 |
| foam (calculated) | | | | | |
| Destroyed sample length | mm | 88 | 89 | 97 | 94 |
| according to DIN 4102 | | | | | |

*Comparative example
¹⁾mass of phosphorus in grams (g) based on the sum of the masses of A1 to A5 and B = 1 kilogram (kg).

Tables 1 and 2 show the use of inventive flame retardant mixtures compared to flame retardant mixtures representative of the prior art. Comparative examples 1 and 3 in each case employ polycyclic phosphate esters having benzene rings as substituents (DPC, A5-3) but which are not compounds of general formula (I) oder (II) in combination with red phosphorus. The use of an inventive flame retardant mixture containing a compound of general formula (I) or (II) in the inventive example 2 affords a rigid PUR/PIR foam having a comparable flame retardancy to the rigid PUR/PIR foam of comparative example 1. However, the compressive strength of the inventive rigid PUR/PIR foam perpendicular to the foaming direction and in the foaming direction is increased and the dimensional stability of the rigid PUR/PIR foam is improved. The same effect is apparent upon comparison of the rigid PUR/PIR foam of comparative example 3 and that of inventive example 4, wherein the flame retardancy of the rigid PUR/PIR foam of inventive example 4 is improved compared to the rigid PUR/PIR foam of comparative example 3.

Comparison of Inventive Flame Retardant Mixture vs. Resorcinyl Diphenylphosphate

In the following examples 5-8 inventive formulations containing the flame retardant mixture A5-1 [bisphenol-A bis(diphenylphosphate) (BDP)]/A5-3 [diphenylcresyl phosphate (DPC)] or A5-1 (BDP)/A5-5 [triethylphosphate (TEP)] are compared with noninventive formulations containing A5-5 [resorcinyldiphenyl phosphate (RDP)] or an RDP/DPC mixture as the flame retardant.

The formulations according to table 2 were processed into polyurethane foams having an index of 148.5 and tested analogously to the examples 1-4.

TABLE 2
Composition of the reaction mixtures and
properties of the foams (examples 5-8)

| Examples | | 5* | 6* | 7 | 8 |
|---|---|---|---|---|---|
| A1-1 | parts by weight | 26.92 | 26.92 | 26.79 | 26.79 |
| A1-2 | parts by weight | 24.23 | 24.23 | 24.11 | 24.11 |
| A1-3 | parts by weight | 7.08 | 7.08 | 7.05 | 7.05 |
| A1-4 | parts by weight | 36.84 | 36.84 | 36.67 | 36.67 |
| A1-5 | parts by weight | 5.67 | 5.67 | 5.64 | 5.64 |
| A2-1 | parts by weight | 4.11 | 4.11 | 4.19 | 4.19 |
| A2-2 | parts by weight | 3.54 | 3.54 | 3.53 | 3.53 |
| A4-2 | parts by weight | 3.54 | 3.54 | 3.53 | 3.53 |
| A3-2 | parts by weight | 1.13 | 1.13 | 1.13 | 1.13 |
| A3-1 | parts by weight | 1.13 | 1.13 | 1.13 | 1.13 |
| Flame retardant | | | | | |
| A5-3 (DPC) | parts by weight | 10.14 | | 10.85 | |
| A5-1 (BDP) | parts by weight | | | 10.85 | 16.27 |
| A5-4 (RDP) | parts by weight | 10.14 | 20.27 | | |
| A5-5 (TEP) | parts by weight | | | | 5.42 |
| Isocyanate | | | | | |
| B-1 | parts by weight | 205.52 | 205.52 | 204.54 | 204.54 |
| Index | | 148.5 | 148.5 | 148.5 | 148.5 |
| Reaction | | | | | |
| parameters | | | | | |
| Cream time | seconds | 17 | 18 | 17 | 18 |
| Fiber time | seconds | 35 | 36 | 35 | 36 |
| Rise time | seconds | 60 | 58 | 58 | 60 |
| Tack-free time | seconds | 85 | 80 | 80 | 76 |
| Physical | | | | | |
| properties of | | | | | |
| the foams | | | | | |
| Apparent density | | 41.3 | 42.2 | 40.0 | 40.0 |
| Open-cell content | % | 6.8 | 7.1 | 7.4 | 7.6 |
| Compressive | kPa | 0.37 | 0.37 | 0.39 | 0.38 |
| strength in | | | | | |
| rise direction | | | | | |
| Compressive | kPa | 0.16 | 0.18 | 0.18 | 0.16 |
| strength | | | | | |
| perpendicular | | | | | |
| to rise | | | | | |
| direction | | | | | |
| Compressive | 1000 m²/s² | 5.1 | 5.3 | 5.8 | 5.4 |
| strength/apparent | | | | | |
| density | | | | | |
| Dimensional | % | 1.3 | 0.9 | 0.3 | 0.5 |
| stability | | | | | |
| @100° C. | | | | | |

Compared to the examples 5 and 6 the inventive foams 7 and 8 have more advantageous apparent densities at identical open-cell content and comparable strength. This results in a more advantageous ratio of strength to density when mixtures of BDP are employed.

Fire characteristics were tested according to ISO 5660-1:2015 (cone calorimeter test with 50 kW/m² output, table 3). All values shown are average values from two measurements. The results show that the inventive BDP-based mixtures are the equals of noninventive RDP and RDP/DPC mixtures or achieve better results. This was not expected on the basis of US 2014/0066532.

TABLE 3
Fire characteristics for examples 5-8

| Examples | | 5* | 6* | 7 | 8 |
|---|---|---|---|---|---|
| Time to ignition, tti | seconds | 4.5 | 3.5 | 4.5 | 5.0 |
| Maximum heat release | kW/m² | 262 | 282 | 235 | 248 |
| rate, HRRₚₑₐₖ | | | | | |
| Total heat release, THR | MJ/m² | 22 | 23 | 22 | 21 |
| Effective heat of combustion, EHC | MJ/m²g | 2.6 | 2.2 | 2.1 | 2.0 |

1. A process for producing a rigid PUR/PIR foam comprising reacting a reaction mixture comprising:
A1 an isocyanate-reactive component;
A2 blowing agent;
A3 catalyst;
A4 optionally additive;
A5 flame retardant; and
B an isocyanate component,
wherein the flame retardant A5 comprises at least two phosphorus-containing compounds, wherein at least one of the two compounds has the general formula
R¹R²(O)P—[O—R⁵—R⁶—O—P(O)R³]ₙR⁴ (I)
or
R¹R²(O)P—[O—R⁵—X—R⁶—O—P(O)R³]ₙR⁴ (II)
wherein
X represents an alkylene group, N—R⁷, O, CO, S, SO, SO₂, or P—R⁷,
n represents an integer having a value from 0 to 4,
R¹, R², R³, and R⁴ each represent an aryl-O, aryl or alkyl group,
R⁵ and R⁶ each represent an arylene group,
R⁷ represents an aryl-O, aryl or alkyl group, and
wherein the at least one compound having the general formula (I) or (II) is employed in an oligomer mixture and n on average has a value n;⁻ of 0.80 to 4.00.

2. The process as claimed in claim 1, wherein the isocyanate-reactive component A1 comprises a polyester polyol.

3. The process as claimed in claim 2, wherein the isocyanate-reactive component A1 comprises a polyester polyol and a polyether polyol each having a molecular weight of 50 g/mol to 2000 g/mol.

4. The process as claimed in claim 2, wherein the isocyanate-reactive component A1 comprises a polyester polyol and a polyether polyol each having a functionality of 1.0 to 6.0.

5. The process as claimed in claim 1, wherein the blowing agent A2 comprises a halogen-free chemical blowing agent, a halogen-free physical blowing agent, a (hydro)fluorinated olefins, or a mixture of any two or more thereof.

6. The process as claimed in claim 1, wherein the compound having the general formula (I) or (II) is present in an amount of 45.0% by weight to 95.0% by weight, based on the total mass of the flame retardant A5.

7. The process as claimed in claim 1, wherein the compound having the general formula (I) or (II) is present in an amount of 5.0% by weight to 40.0% by weight, based on the total mass of the components A1 to A5.

8. The process as claimed in claim 1, wherein the flame retardant A5 contains no halogen-containing flame retardant.

9. The process as claimed in claim 1, wherein R¹, R², R³ and R⁴ each represent an aryl-O group.

10. The process as claimed in claim 9, wherein R¹, R², R³ and R⁴ each represent a phenoxy group.

11. The process as claimed in claim 10, wherein the compound having the general formula (I) or (II) comprises bisphenol A bis(diphenylphosphate).

12. The process as claimed in claim 1 to 11, wherein the flame retardant A5 further comprises at least one of diphenylcresyl phosphate, triethyl phosphate and red phosphorus.

13. The process as claimed in claim 1, wherein the isocyanate component B comprises at least one of MDI, polymeric MDI and TDI.

14. A rigid PUR/PIR foam obtained by the process as claimed in claim 1.

15. An insulation material comprising the rigid PUR/PIR foams as claimed in claim 14.
